(19) United States
(12) Patent Application Publication
(10) Pub. No.: US 2013/0196142 A1
(43) Pub. Date: Aug. 1, 2013

(54) DOUBLE-FACED PRESSURE-SENSITIVE ADHESIVE SHEET

(71) Applicant: NITTO DENKO CORPORATION, Osaka (JP)

(72) Inventors: Kenichi YAMAMOTO, Ibaraki-shi (JP); Akiko TAKAHASHI, Ibaraki-shi (JP)

(73) Assignee: NITTO DENKO CORPORATION, Osaka (JP)

(21) Appl. No.: 13/748,974

(22) Filed: Jan. 24, 2013

(30) Foreign Application Priority Data
Jan. 26, 2012 (JP) 2012-013736
Jan. 7, 2013 (JP) 2013-000735

(51) Int. Cl. C09J 7/02

(52) U.S. Cl. CPC C09J 7/0217; C09J 7/0246
USPC 428/317.3; 428/355 AC

(57) ABSTRACT

Provided is a double-faced PSA sheet comprising a first PSA layer formed of a first PSA composition comprising an acrylic polymer P_{A} as a base polymer and a second PSA layer formed of a second PSA composition comprising an acrylic polymer P_{B} as a base polymer provided respectively on a first face and a second face of a substrate. The weight average molecular weights Mw_{A} and Mw_{B} of the dried THF-soluble portions of the first and the second PSA compositions satisfy the next inequalities: Mw_{A}≧80×10⁴; Mw_{B}<80×10⁴; (Mw_{A}−Mw_{B})≧10×10⁴.

### BACKGROUND OF THE INVENTION

1. Field of the Invention

The present application relates to a double-faced pressure-sensitive adhesive (PSA) sheet comprising a PSA layer formed of a PSA composition on each face (a first face and a second face) of a substrate.

The present application claims priority based on Japanese Patent Application No. 2012-013736 filed on Jan. 26, 2012 and Japanese Patent Application No. 2013-000735 filed Jan. 7, 2013, and the entire contents thereof are incorporated herein by reference.

2. Description of the Related Art

An adhesively double-faced PSA sheet (double-faced PSA sheet) comprising a PSA layer on each face of a substrate is widely used as an efficient and highly dependable means for attachment in various industrial fields such as home appliances, automobiles, electronic devices, OA devices, and so on.

In late years, from the standpoint of saving natural resources, with respect to recyclable components used in products, there has been an increased number of cases where used products are disassembled, and these components or their constituents are reused (recycled). When another member is attached to the component intended for reuse (component for recycling) via a double-faced PSA sheet, the component for recycling is usually subjected to recycling upon removal of the other member along with the double-faced PSA sheet. During the removal, if a fracture (an interlaminar fracture) occurs in a way where the double-faced PSA sheet is split into the thickness direction inside the substrate (e.g., non-woven fabric), or if the surface of the component for recycling is left with partially remaining PSA (adhesive residues), the efficiency of the recycling process significantly decreases because of the operations to remove these residues of the double-faced PSA sheet from the surface of the recycling component. Technical literatures relating to improvement in such events (increasing recyclability) include Japanese Patent Application Publication Nos. 2006-143856, 2001-152111 and 2000-265140.

### SUMMARY OF THE INVENTION

Applications of a double-faced PSA sheet include its use in fixing a porous member such as a foam (e.g., flexible foam such as soft urethane foam, etc.) or a non-woven fabric, etc., to a desired part of a resin compact. Such a porous member can be used, for instance, for purposes of preventing the occurrence of strange noises (rattle (a short repeated sound), creak, etc.) caused by frictions (interferences) between a resin compact and other components, protecting a resin compact from impacts and absorbing crashing noises, filling spaces between a resin compact and other components, and so forth. It is desired that a double-faced PSA sheet to fix such a porous member onto a resin compact (which may be a component for recycling) exhibits good adhesion to both the porous member surface and the resin compact, and also it shows good removability from the resin compact. However, since the adhesion to a porous member surface (rough surface adhesion) and the removability therefrom are generally two opposing properties, it has been difficult to obtain a double-faced PSA sheet that combines satisfactory levels of these properties.

The present invention has been made in view of such a situation, and one objective thereof is to provide a double-faced PSA sheet that shows good rough surface adhesion as well as good removability.

The present invention provides a double-faced PSA sheet comprising a substrate having a first face and a second face, a first PSA layer provided on the first face, and a second PSA layer provided on the second face. The first PSA layer is formed of a first PSA composition comprising an acrylic polymer P_{A} as a base polymer. The second PSA layer is formed of a second PSA composition comprising an acrylic polymer P_{B} as a base polymer. The double-faced PSA sheet is such that when Mw_{A} is the weight average molecular weight of the tetrahydrofuran(THF)-soluble portion of the first PSA composition after dried and Mw_{B} is the weight average molecular weight of the THF-soluble portion of the second PSA composition after dried, Mw_{A} and Mw_{B} satisfy the following inequalities (1) to (3):

Mw_{A}≧80×10⁴ (1)

Mw_{B}<80×10⁴ (2)

(Mw_{A}−Mw_{B})≧10×10⁴ (3)

In a double-faced PSA sheet having such a constitution, the first PSA layer may exhibit good removability from an adherend (e.g., a component for recycling such as a resin compact, etc.) while the second PSA layer may exhibit good adhesion (pressure-sensitive adhesion) to rough surfaces such as porous member surfaces and the like. Thus, the double-faced PSA sheet may be preferably used for fixing a porous member onto a component for recycling as well as for other purposes.

In a preferable embodiment, at least one of the acrylic polymer P_{A} and the acrylic polymer P_{B} is a polymer obtained by polymerizing monomer components comprising two kinds of alkyl (meth)acrylate, Ama1 and Ama2, with their alkyl groups having different numbers of carbon atoms. When Ama1 and Ama2 are the only two alkyl (meth)acrylates contained in the monomer components, the total amount of Ama1 and Ama2, Ama_{T}, equals to the total amount of alkyl (meth)acrylates contained in the monomer components (i.e., they account for 100% by mass of the total amount). When the monomer components contain three kinds or more of alkyl (meth)acrylate, it is preferable that among the alkyl (meth)acrylates contained in the monomer components, the Ama1 and Ama2 are the top two components in descending order of content by mass. In this case, the total amount of Ama1 and Ama2, Ama_{T}, is preferably 40% by mass or greater (typically 40% by mass or greater, but less than 100% by mass) of the total amount of the alkyl (meth)acrylates contained in the monomer components.

In the double-faced PSA sheet disclosed herein, the acrylic polymer P_{B} contained in the second PSA composition preferably has a glass transition temperature, Tg_{B} (° C.), of −20° C. or below (i.e., Tg_{B}≦−20° C.). Such a double-faced PSA sheet may be such that its second PSA layer exhibits better rough surface adhesion. The acrylic polymer P_{A} contained in the first PSA composition typically has a glass transition temperature, Tg_{A} (° C.), of −20° C. or below, and it is preferable that Tg_{A} is lower than Tg_{B} by 10° C. or more (i.e., (Tg_{B}−Tg_{A})≧10° C.). The double-faced PSA sheet in such an embodiment may be such that its first PSA layer has even better removability (e.g., a nature that is less likely to leave adhesive residues on adherend surfaces).

The first PSA composition after dried preferably has a mass fraction (gel fraction) G_{A} of its ethyl acetate-insoluble portion of 30% by mass or greater. Such a double-faced PSA sheet may be such that its first PSA layer has good removability (e.g., a nature that is less likely to leave adhesive residues on adherend surfaces). The second PSA composition after dried preferably has a mass fraction (gel fraction) G_{B} of its ethyl acetate-insoluble portion of 50% by mass or smaller. Such a double-faced PSA sheet may be such that its second PSA layer exhibits even better rough surface adhesion.

The first PSA layer may comprise a tackifier resin having a softening point of 125° C. or above. In such a double-faced PSA sheet, the first PSA layer may have high adhesive strength, and also the first PSA layer may have even better removability (e.g., a nature that is less likely to leave adhesive residues on adherend surfaces). The second PSA layer may comprise a tackifier resin having a softening point below 155° C. (e.g., 150° C. or below). In such a double-faced PSA sheet, the second PSA layer may exhibit even better rough surface adhesion.

In a preferable embodiment of the double-faced PSA sheet disclosed herein, when the second PSA layer is pressure-bonded to a 10 mm thick soft urethane foam (product name “ECS” (gray-colored) available from Inoac Corporation is used) until the urethane foam is compressed to a thickness of 1 mm, after a lapse of 30 minutes from the pressure-bonding, the second PSA layer exhibits a 180° peel strength of 1.5 N/20 mm or greater. Because such a double-faced PSA sheet has a second PSA layer with good rough surface adhesion, it is preferable for fixing soft urethane foam and other porous members onto resin compacts (which may be components for recycling).

### BRIEF DESCRIPTION OF THE DRAWINGS

FIG. 1 shows a cross-sectional view schematically illustrating a representative example of configuration of a double-faced PSA sheet.

FIG. 2 shows a cross-sectional view schematically illustrating another representative example of configuration of a double-faced PSA sheet.

FIG. 3 shows a diagram illustrating the method for measuring the adhesive strength against urethane foam.

FIG. 4 shows a diagram illustrating the method for measuring the adhesive strength against urethane foam.

### DETAILED DESCRIPTION OF THE INVENTION

Preferred embodiments of the present invention are described below. Matters necessary to practice this invention other than those specifically referred to in this description may be understood as design matters to a person of ordinary skills in the art based on the conventional art in the pertinent field. The present invention can be practiced based on the contents disclosed in this description and common technical knowledge in the subject field.

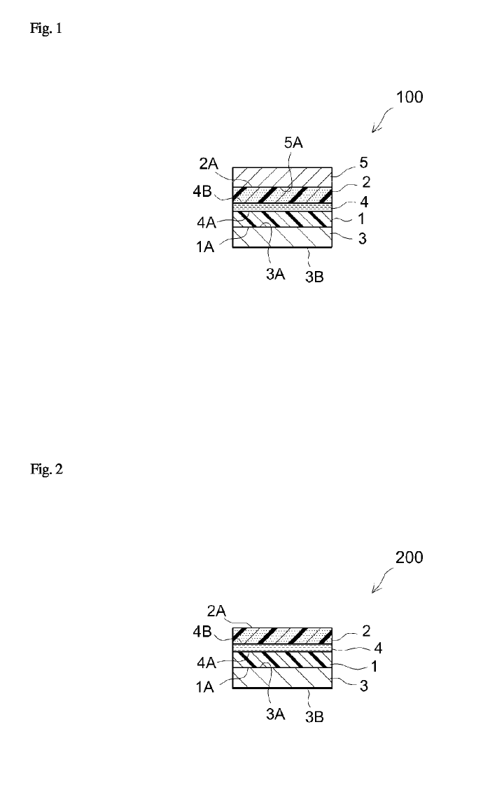

The double-faced PSA sheet (which can be a long sheet such as tape, etc.) disclosed herein may have a cross-sectional structure shown in FIG. 1 or FIG. 2.

A double-faced PSA sheet 100 shown in FIG. 1 has a first PSA layer 1 and a second PSA layer 2 on a first face 4A and a second face 4B of a substrate 4, respectively. On the tops of a surface (a first adhesive face) 1A of the first PSA layer 1 and a surface (a second adhesive face) 2A of the second PSA layer 2, release liners 3 and 5 are placed, respectively, of which at least the PSA-layer-side surfaces (i.e., surfaces facing the PSA layers) 3A and 5A are release surfaces. A double-faced PSA sheet 200 shown in FIG. 2 has the same configuration as the double-faced PSA sheet 100 shown in FIG. 1, except that the release liner 3 placed on top of the first PSA layer is releasable on both surfaces (i.e., the PSA-layer-side surface 3A and its back face 3B are both release surfaces) and it does not have a release liner 5 covering the second PSA layer 2. The double-faced PSA sheet 200 of this type can be turned into a configuration where the second PSA layer 2 is also protected with the release liner 3, by winding the PSA sheet 200 to allow the second PSA layer 2 to contact the release surface 3B on the reverse side (back side) of the release liner 3.

As the substrate 4, can be used various kinds of resin film (polyolefin film, polyester film, etc.), woven fabrics and non-woven fabrics (meaning to include paper such as Washi, high-grade paper, etc.) of a single species or a blend, etc., of various kinds of fibrous substances, rubber sheets (natural rubber sheets, etc.), foam sheets (polyurethane foam sheets, etc.) made of foam such as polychloroprene rubber foam, etc., metal foils (aluminum foil, etc.), composites of these, and so on. The substrate 4 may have a form of a single layer or a layered structure. Although the thickness of the substrate can be suitably selected in accordance with the purpose, it is usually suitable to be 5 μm to 150 μm (preferably 10 μm to 100 μm, more preferably 30 μm to 100 μm, e.g., 50 μm to 100 μm). When the thickness of the substrate is excessively large, the curved surface adhesion may tend to decrease, or the impregnation with PSA may be insufficient and an interlaminar fracture may be likely to occur. When the thickness of the substrate is too small, the strength of the double-faced PSA sheet may be insufficient and the PSA sheet may tend to be torn off in the process of its removal.

As the substrate of the double-faced PSA sheet disclosed herein, can be preferably used a non-woven fabric known or commonly used in the field of double-faced PSA sheets. Examples of a usable material include a non-woven fabric (which may be a non-woven fabric fabricated using a general paper machine (such non-woven fabric may be referred to as so-called “paper”)) constituted with a natural fiber such as wood pulp, cotton, hemp (e.g., Manila hemp), and the like; a non-woven fabric constituted with an artificial fiber (a synthetic fiber) such as polyester fiber, rayon, vinylon, acetate fiber, polyvinyl alcohol (PVA) fiber, polyamide fiber, polyolefin fiber, polyurethane fiber, and the like; a non-woven fabric constituted with two or more materially-different kinds of fiber; and so on.

Non-woven fabrics preferable for the present invention include a non-woven fabric comprising a cellulose-based fabric (which encompasses recycled fibers of natural fibers and rayon, etc.; typically a natural fiber) as its primary constituent fiber. A non-woven fabric having such a fiber composition may combine strength and adequate flexibility. Thus, by using such a non-woven fabric as the substrate, can be obtained a double-faced PSA sheet having good removability and other good adhesive properties (e.g., good curved surface adhesion). Among the fibers constituting the non-woven fabric, the cellulose-based fiber accounts for typically about 50% by mass or greater, preferably about 70% by mass or greater, or more preferably about 85% by mass or greater. In a preferable embodiment of the invention disclosed herein, as the non-woven fabric, is used a non-woven fabric formed of a constituent fiber consisting essentially of a cellulose-based fiber (e.g., 100% hemp).

The non-woven fabric may have been subjected to processing (typically an impregnation treatment) with a resin (binder) such as viscose, starch, PVA, polyacrylamide, or the like. From the standpoint of the strength (e.g., tensile strength), etc., of the non-woven fabric, can be preferably used a non-woven fabric that has been subjected to so-called viscose processing (a viscose impregnation process). The concept of “viscose” as referred to herein includes a viscose-based material used as a binder or a paper strengthening agent in the field of non-woven fabrics (especially, the non-woven fabrics utilized as substrates for double-faced PSA sheets). The viscose-based material used in the so-called viscose processing (viscose impregnation process) in this field is a typical example included in the concept of viscose as referred to herein.

Although not particularly limited, as the non-woven fabric in the art disclosed herein, can be preferably used a non-woven fabric having a grammage of about 13 g/m² or greater (typically about 13 g/m² to 30 g/m²). By using a non-woven fabric having a grammage of about 15 g/m² to 25 g/m² (for instance 15 g/m² to 20 g/m²), a higher level of removability can be realized. The non-woven fabric may have a bulk density (which can be calculated by dividing the grammage by the thickness) of, for example, about 0.2 g/cm³ to 0.5 g/cm³ (typically 0.2 g/cm³ to 0.4 g/cm³). A non-woven fabric having such a bulk density is especially suitable for forming a PSA layer that is sufficiently integrated in the non-woven fabric.

It is preferable to use a high strength non-woven fabric as the substrate from the standpoint such as that it is less susceptible to tearing and contributes to easy peeling when the double-faced PSA sheet is removed (e.g., when one end of the double-faced PSA sheet is taken and peeled away from a surface of a post-disassembly component, it can be continuously peeled off through the other end without tearing along the way). For instance, It is preferable that the tensile strength measured based on JIS P8113 is 10 N/15 mm or greater in either of the machine direction (MD) and the transverse direction (TD), or it is more preferable that it is about 15 N/15 mm or greater. Although the upper limitation of the tensile strength is not particularly limited, from the standpoint of costs and the curved surface adhesion, etc., can be preferably used a non-woven fabric having a tensile strength of about 50 N/15 mm or smaller in both MD and TD. For example, a preferable double-faced PSA sheet comprises a non-woven fabric substrate having a tensile strength of about 10 N/15 mm to 50 N/15 mm (more preferably about 15 N/15 mm to 50N/15 mm) in both MD and TD. It is especially preferable to use a non-woven fabric that satisfies all of the above thickness, grammage, as well as MD and TD tensile strength values. A double-faced PSA sheet using such a non-woven fabric as the substrate may be of even better removability.

The PSA layers of the double-faced PSA sheet disclosed herein are described more in detail next.

The first PSA layer and the second PSA layer in the art disclosed herein may be each independently a PSA layer formed of a PSA composition in various forms, such as a water-based PSA composition (PSA composition in a form containing PSA (PSA-layer-forming components) in a solvent comprising water as a primary component (water-based solvent)), a solvent-based PSA composition (PSA composition in a form containing PSA in an organic solvent), a non-solvent-type PSA composition (organic-solvent-free PSA composition curable by irradiation of an activating energy ray such as ultraviolet ray or an electron beam, etc.; hot-melt-type PSA composition; or the like), and other types. The concept of water-based PSA composition as referred to herein includes those so-called water-dispersed PSA compositions (compositions in forms where PSA is dispersed in water), water-soluble PSA compositions (compositions in forms where PSA is dissolved in water), and the like.

In the double-faced PSA sheet according to a preferable embodiment, at least one (preferably each) of the first PSA layer and the second PSA layer is a PSA layer (an aqueous PSA layer) formed of an aqueous PSA composition. A double-faced PSA sheet of such a constitution is preferable from the standpoint of such as environmental concerns, reducing the amounts of volatile organic compounds (VOC) released from the double-faced PSA sheet, and so on. Incidentally, as compared to a double-faced PSA sheet formed with a solvent-based PSA composition, a double-faced PSA sheet formed with an aqueous PSA composition (e.g., a water-dispersed PSA composition) is likely to provide insufficient removability (likely to leave residues of the double-faced PSA sheet on the surface of a component for recycling) and also tends to exhibit insufficient adhesion (rough surface adhesion) against the surface of a porous member, it has been especially difficult to combine high levels of rough surface adhesion and removability. Therefore, when at least one (preferably each) of the first PSA composition and the second PSA composition is a water-based PSA composition (especially, a water-dispersed PSA composition), it is particularly meaningful to achieve high levels of rough surface adhesion and removability at the same time by applying the art disclosed herein.

These first and second PSA layers are each formed of a PSA composition comprising an acrylic polymer as a base polymer. In each PSA layer, the acrylic polymer accounts for preferably 40% by mass or greater (typically 40 to 95% by mass) or more preferably 50% by mass or greater (typically 50 to 90% by mass, e.g., 55 to 85% by mass). When the acrylic polymer content is too large or too small, the balance of the adhesive properties may likely be disturbed.

Each of the acrylic polymer P_{A} as the base polymer of the first PSA layer and the acrylic polymer P_{B} as the base polymer of the second PSA layer preferably comprises an alkyl (meth)acrylate as a primary monomer component (a primary component of monomers, i.e., a component accounting for 50% by mass or greater, typically 50 to 99.8% by mass, of the total amount of monomers constituting the acrylic polymer (which hereinafter may be referred to as “all monomer components)). In a preferable embodiment, the alkyl (meth)acrylate content is 70% by mass or greater (typically 70 to 99.5% by mass) of all monomer components, for instance, 80% by mass or greater (typically 80 to 99.5% by mass). The alkyl (meth)acrylate content can be 90% by mass or greater (typically 90 to 99% by mass) of all monomer components. Such an acrylic polymer can be synthesized by subjecting a prescribed monomer material to polymerization (typically emulsion polymerization). Usually, the composition of the monomer material approximately corresponds to the copolymer composition (copolymerization ratio) of the acrylic polymer obtainable by polymerizing the monomer material.

In the present description, the term “(meth)acrylate” comprehensively refers to acrylate and methacrylate. Similarly, the term “(meth)acryloyl” comprehensively refers to acryloyl and methacryloyl, and the term “(meth)acrylate” comprehensively refers to acrylate and methacrylate.

As the alkyl (meth)acrylate, can be preferably used one, two or more kinds selected from (meth)acrylic acid esters of alkyl alcohols having 1 to 20 carbon atoms (hereinafter, such a number range of carbon atoms may be indicated as C₁₋₂₀). As the alkyl group in the alkyl (meth)acrylate, an acyclic alkyl group (i.e., in a chain form (including a straight chain and a branched chain)) is preferable. In a preferable embodiment, 70% by mass or greater (typically 70 to 99.5% by mass) of all monomer components is a C₁₋₁₄ alkyl (meth)acrylate, for instance, a C₁₋₁₀ alkyl (meth)acrylate. Examples of a C₁₋₁₀ alkyl (meth)acrylate include methyl (meth)acrylate, ethyl (meth)acrylate, n-propyl (meth)acrylate, isopropyl (meth)acrylate, n-butyl (meth)acrylate, isobutyl (meth)acrylate, s-butyl (meth)acrylate, t-butyl (meth)acrylate, n-pentyl (meth)acrylate, isoamyl (meth)acrylate, neopentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and the like. For instance, a preferably employed monomer composition may contain one or both of n-butyl acrylate (BA) and 2-ethylhexyl acrylate (2EHA) for a total of 40% by mass or greater (typically, 40 to 98% by mass) of all monomer components, or more preferably 50% by mass or greater (typically 50 to 95% by mass). When BA and 2EHA are used in combination as the alkyl (meth)acrylate, their ratio is not particularly limited.

At least one (e.g., possibly P_{B}, or both P_{A} and P_{B}) of the acrylic polymer P_{A} and the acrylic polymer P_{B} is preferably a polymer obtained by polymerizing monomer components containing two different alkyl (meth)acrylates Ama1 and Ama2, with their alkyl groups having different numbers of carbon atoms. For instance, can be preferably employed an embodiment in which one of Ama1 and Ama2 is 2EHA and the other is BA, and an embodiment in which one of Ama1 and Ama2 is 2EHA and the other is methyl acrylate (MA). The monomer components may contain as the alkyl (meth)acrylate only two species, with them being Ama1 and Ama2. Alternatively, the monomer components may contain three or more species of alkyl (meth)acrylate. In this case, it is preferable that among the alkyl (meth)acrylates contained in the monomer components, the Ama1 and Ama2 are the top two components in descending order of content by mass. In this case, the total amount of Ama1 and Ama2, Ama_{T}, is preferably 40% by mass or greater (typically 40% by mass or greater, but less than 100% by mass; for instance, 70% by mass or greater, but less than 100% by mass) of the total amount of the alkyl (meth)acrylate.

As an optional component, another monomer that is copolymerizable with alkyl (meth)acrylate (which hereinafter may be referred to as “copolymerizing monomer”) can be used in the acrylic polymer. For instance, can be used an ethylenic unsaturated monomer (a functional-group-containing monomer) having one, two or more kinds of functional group selected from carboxyl group, alkoxysilyl group, hydroxyl group, amino group, amide group, epoxy group, and the like. These functional-group-containing monomers may be useful for introducing a crosslinking point into the acrylic polymer. The type of copolymerizing monomer and the proportion (copolymerization ratio) thereof can be suitably selected in view of the type of the crosslinking reaction, the desired extent of crosslinking (which can be assessed by the gel fraction), and so on.

Of these functional-group-containing monomers, can be preferably used one, two or more kinds selected from monomers containing a carboxyl group or acid anhydrides thereof. Examples of a carboxyl-group containing monomer include ethylenic unsaturated monocarboxylic acids such as acrylic acid (AA), methacrylic acid (MAA), crotonic acid, etc.; ethylenic unsaturated dicarboxylic acids such as maleic acid, itaconic acid and citraconic acid, etc.; anhydrides of ethylenic unsaturated dicarboxylic acids such as maleic acid anhydride, itaconic acid anhydride, etc.; and the like. Essentially all the functional-group-containing monomer components may be carboxyl-group-containing monomers. Particularly preferable examples of a carboxyl-group-containing monomer include AA and MAA. One of these may be used solely, or AA and MAA may be used together in a desired ratio.

In usual, the functional-group-containing monomer is preferably used within a range of 15% by mass or less (e.g., 0.5 to 15% by mass, preferably 1 to 10% by mass) of all monomer components. Too large an amount of a functional-group-containing monomer may result in excessively high cohesive strength whereby the adhesive properties (e.g., adhesive strength) may tend to decrease.

In a preferable embodiment of the art disclosed herein, AA and MAA are copolymerized in the acrylic polymer. According to a PSA composition containing an acrylic polymer of such a copolymer composition, can be obtained a PSA sheet having even better rough surface adhesion, which is described later. The mass ratio of AA to MAA (AA:MAA) can be, for instance, in a range of about 1:10 to 10:1, and it is usually preferable to be in a range of about 1:4 to 4:1 (e.g., 1:2 to 2:1). When a carboxyl-group-containing monomer is copolymerized, the copolymerized amount thereof (when several kinds of carboxyl-group-containing monomer are used, their total amount) can be, for instance, about 0.5 to 15% by mass of all monomer components, and it is usually suitable to be about 0.5 to 10% by mass (preferably 1 to 6% by mass, e.g., 1 to 5% by mass).

Other preferably usable examples of a functional-group-containing monomer include monomers containing an alkoxysilyl-group. Examples of alkoxysilyl-group-containing monomers include γ-(meth)acryloxypropyltrimethoxysilane, γ-(meth)acryloxypropyltriethoxysilane, γ-(meth)acryloxypropylmethyldimethoxysilane, γ-(meth)acryloxypropylmethyl-diethoxysilane, and the like. When such an alkoxysilyl-group-containing monomer is copolymerized, the copolymerized amount thereof can be about 0.005 to 0.05% by mass (e.g., 0.01 to 0.03% by mass) of all monomer components.

In a preferable embodiment of the art disclosed herein, at least an alkoxysilyl-group-containing monomer and at least one of AA and MAA (typically AA and MAA) are copolymerized as the functional-group-containing monomer in the acrylic polymer. The acrylic polymer may consist essentially of an alkyl (meth)acrylate, an alkoxysilyl-group-containing monomer, and at least one of AA and MAA (typically AA and MAA).

Other examples of a monomer (copolymerizing monomer) that can be copolymerized in the acrylic polymer include vinyl esters such as vinyl acetate, vinyl propionate, etc.; aromatic vinyl compounds such as styrene, α-methyl styrene, etc.; non-aromatic-ring-containing (meth)acrylates such as cyclohexyl (meth)acrylate, isobornyl (meth)acrylate, etc.; aromatic-ring-containing (meth)acrylates such as phenyl (meth)acrylate, benzyl (meth)acrylate, etc.; alkoxy-group-containing monomers such as methoxyethyl (meth)acrylate, ethoxyethyl (meth)acrylate, etc.; vinyl ethers such as methyl vinyl ether, ethyl vinyl ether, etc.; and so on. Yet other examples include multifunctional monomers having several polymerizing functional groups per molecule such as ethylene glycol di(meth)acrylate, pentaerythritol di(meth)acrylate, trimethylolpropane tri(meth)acrylate, pentaerythritol tri(meth)acrylate, dipentaerythritol hexa(meth)acrylate, and the like. Alternatively, such multifunctional monomers may not be used substantially.

Acrylic polymer P_{A} as the base polymer of the first PSA layer preferably has a glass transition temperature Tg_{A} between −70° C. to −30° C. (more preferably −60° C. to −35° C., e.g., −55° C. to −40° C.). When Tg_{A} is too high, the removability of the first PSA layer may tend to decrease (e.g., adhesive residues may be left, or an interlaminar fracture may be likely to occur). On the other hand, when Tg_{A} is too low, the adhesive strength of the first PSA layer tend to be low, and the cohesive strength or the rough surface adhesion may tend to be insufficient.

Acrylic polymer P_{B} as the base polymer of the second PSA layer may have a glass transition temperature Tg_{B} of −20° C. or below (typically −70° C. to −20° C.). Tg_{B} is preferably between −60° C. to −20° C. (more preferably −50° C. to −25° C., e.g., −40° C. to −25° C.). When Tg_{B} is too high, the rough surface adhesion of the second PSA layer may tend to decrease. On the other hand, when Tg_{B} is too low, the cohesive strength or the curved surface adhesion of the second PSA layer may tend to be insufficient.

The Tg value of an acrylic polymer as referred to herein is a value calculated by the Fox equation based on the Tg values of the homopolymers of the respective monomers and the mass fractions (copolymerization ratio) of these monomers. The Tg values of some homopolymers to be used are −70° C. for 2EHA, −54° C. for BA, 8° C. for methyl acrylate (MA), 105° C. for methyl methacrylate, 66° C. for cyclohexyl methacrylate, 32° C. for vinyl acetate, 106° C. for AA, and 228° C. for MAA.

With respect to the Tg values of homopolymers other than the examples listed above, the values given in “Polymer Handbook” (3rd edition, John Wiley & Sons, Inc., Year 1989) are used. When several values are given for the same homopolymer, the value that is “conventional” is used.

When no values are given in the “Polymer Handbook”, values obtained by the following measurement method are used (see Japanese Patent Application Publication No. 2007-51271). In particular, to a reaction vessel equipped with a thermometer, a stirrer, a nitrogen inlet and a condenser, are added 100 parts by mass of monomer, 0.2 part by mass of azobisisobutyronitrile, and 200 parts by mass of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having a non-volatiles content of 33% by mass is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and using a rheometer (ARES, available from Rheometrics Scientific, Inc.), while applying a shear strain at a frequency of 1 Hz, the viscoelasticity is measured in the shear mode over a temperature range of −70° C. to 150° C. at a heating rate of 5° C./min; and the temperature value at the top of the tan δ peak is determined as the Tg of the homopolymer.

As a method for obtaining an acrylic polymer by polymerizing such monomers, can be suitably employed a known or commonly used polymerization method in accordance with the form of the PSA composition of interest. For instance, when a water-dispersed PSA composition is prepared, an emulsion polymerization method can be preferably employed.

As a method for supplying monomers when emulsion polymerization is carried out, can be suitably employed a method such as the all-at-once supply method, gradual supply (dropping) method, portionwise supply (dropping) method, etc. All or a portion (typically all) of the monomers may be mixed and emulsified with water in advance, and the resulting emulsion (monomer emulsion) can be supplied into the reaction vessel, all at once, gradually, or portionwise. The polymerization temperature can be suitably selected according to the types of monomer used, the type of polymerization initiator used and so on. For example, it can be about 20° C. to 100° C. (typically 40° C. to 80° C.). For instance, an emulsion prepared by mixing and emulsifying all of the monomer material in water aforetime may be gradually supplied into the reaction vessel over about 2 to 8 hours (preferably 3 to 5 hours).

The polymerization initiator used in polymerization can be suitably selected from known or commonly used polymerization initiators in accordance with the type of the polymerization method. For instance, in an emulsion polymerization method, an azo-based polymerization initiator can be preferably used. Examples of an azo-based polymerization initiator include 2,2′-azobisisobutyronitrile, 2,2′-azobis(2-methylpropionamidine) disulfate salt, 2,2′-azobis(2-amidinopropane) dihydrochloride, 2,2′-azobis[2-(5-methyl-2-imidazolin-2-yl)propane]dihydrochloride, 2,2′-azobis(N,N′-dimethylene isobutylamidine), 2,2′-azobis[N-(2-carboxyethyl)-2-methylpropionamidine]hydrate, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methylpropionate), and so on.

Other examples of the polymerization initiator include persulfate salts such as potassium persulfate, ammonium persulfate, etc.; peroxide-based initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane, hydrogen peroxide, etc.; and so on. Yet other examples of the polymerization initiator include redox-based initiators, with each combining a peroxide and a reducing agent. Examples of such redox-based initiators include a combination of a peroxide (hydrogen peroxide, etc.) and ascorbic acid, a combination of a persulfate and sodium hydrogen sulfite, and so on.

These polymerization initiators can be used as a single kind or in combination of two or more kinds. The polymerization initiator can be used in a usual amount, which can be selected, for instance, from a range of about 0.005 to 1 part by mass (typically 0.01 to 1 part by mass) relative to 100 parts by mass of all monomer components.

In the polymerization, as necessary, can be used a chain transfer agent (which can be understood also as a molecular-weight-adjusting agent or a polymerization-degree-adjusting agent) of various kinds heretofore known. Such chain transfer agent may be, for instance, one, two or more kinds selected from mercaptans such as n-lauryl mercaptan, tert-lauryl mercaptan, glycidyl mercaptan, 2-mercaptoethanol, and so on. Among these, use of tert-lauryl mercaptan is preferable. The amount of the chain transfer agent used can be, for instance, about 0.001 to 0.5 part by mass relative to 100 parts by mass of the monomer material. This amount can be about 0.02 to 0.05 part by mass.

According to such emulsion polymerization, can be obtained a polymerization reaction mixture as an emulsion where the acrylic polymer is dispersed in water. The water-dispersed PSA composition in the art disclosed herein can be prepared using the polymerization reaction mixture or a water dispersion obtained by subjecting the reaction mixture to a suitable work-up process. Alternatively, the acrylic polymer can be synthesized by a polymerization method (e.g., solution polymerization, photopolymerization, bulk polymerization, etc.) other than the emulsion polymerization method, and a water dispersion prepared by dispersing this polymer in water can be used.

In preparation of a water dispersion of acrylic polymer, an emulsifier can be used as necessary. As the emulsifier, any of anionic, non-ionic, and cationic emulsifiers can be used. Usually, an anionic or a non-ionic emulsifier is preferably used. Such an emulsifier can be used preferably in instances, such as when the monomer material is subjected to emulsion polymerization, or when an acrylic polymer obtained by a different method is dispersed in water. Examples of an anionic emulsifier include sodium lauryl sulfate, ammonium lauryl sulfate, sodium dodecyl benzene sulfonate, sodium polyoxyethylene alkyl ether sulfate, ammonium polyoxyethylene alkyl phenyl ether sulfate, sodium polyoxyethylene alkyl phenyl ether sulfate, and so on. Examples of a non-ionic emulsifier include polyoxyethylene alkyl ether, polyoxyethylene alkyl phenyl ether, and the like. A radically polymerizable emulsifier (reactive emulsifier) having a structure with a radically polymerizable group (e.g., propenyl group, etc.) introduced into such an anionic or non-ionic emulsifier described above may also be used. Alternatively, an emulsifier not having such a radically polymerizable group may be used solely.

These emulsifiers can be used solely as a single kind, or in combination of two or more kinds. An emulsifier can be used in an amount that allows preparation of the acrylic polymer in an emulsion form and the amount used is not particularly limited. Usually, it can be suitably selected from, for instance, a range of about 0.2 to 10 parts by mass (preferably about 0.5 to 5 parts by mass) relative to 100 parts by mass of the acrylic polymer based on the solids content.

When preparing a solvent-based PSA composition, a solution polymerization method can be preferably employed as the method for obtaining the acrylic polymer. As the polymerization solvent in solution polymerization, can be used ethyl acetate, toluene, methyl ethyl ketone, methyl isobutyl ketone, and the like. The solvents can be used alone as a single kind, or as a mixture of two or more kinds. A preferable example of the polymerization solvent is a polymerization solvent having a composition essentially free of toluene (e.g., consisting essentially of ethyl acetate).

The PSA composition used in the art disclosed herein may comprise, as added where necessary, a general cross-linking agent, with the cross-linking agent being selected from, for instance, carbodiimide-based cross-linking agents, hydrazine-based cross-linking agents, epoxy-based cross-linking agents, isocyanate-based cross-linking agents, oxazoline-based cross-linking agents, aziridine-based cross-linking agents, metal-chelate-based cross-linking agents, and silane coupling agents, and so on. These cross-linking agents can be used alone as a single kind or in combination of two or more kinds. The PSA composition may be prepared by obtained by adding and mixing the general crosslinking agent to a water dispersion of an acrylic polymer emulsion which has been obtained by emulsion polymerization and subjected to a suitable work-up process (pH adjustment, etc.). Alternatively, it may be a PSA composition essentially free of such a crosslinking agent added afterwards (added after the emulsion polymerization process). In a preferable embodiment, at least one (typically each) of the first PSA composition and the second PSA composition is a PSA composition in which an alkoxysilyl-group-containing monomer (preferably, even one or both of AA and MAA) is used as the functional-group-containing monomer, but the crosslinking agent added afterwards is not used substantially.

Each of the first and second PSA compositions may or may not further comprise a tackifier. As such a tackifier, can be used various kinds of tackifier resin such as a rosin-based resin, a rosin derivative resin, a petroleum-based resin, a terpene-based resin, a phenol-based resin, a ketone-based resin, and so on. These tackifier resins can be used solely as a single kind, or in combination of two ore more kinds. In preparation of a water-dispersed (emulsion-type) PSA composition, can be used preferably a water dispersion (a tackifier resin emulsion) where such a tackifier resin is dispersed in water. For instance, a tackifier resin emulsion can be added to the water dispersion of the acrylic polymer.

Examples of commercial tackifier resin (including those dispersed in aqueous media) include trade names “SUPER ESTER E-865”, “SUPER ESTER E-865NT”, “SUPER ESTER E-200NT”, “SUPER ESTER NS-100H”, “SUPER ESTER E-650”, “SUPER ESTER E-786-60”, “TAMANOL E-100”, “TAMANOL E-200”, “TAMANOL 803L”, “PENSEL D-160”, “PENSEL KK” available from Arakawa Chemical Industries, Ltd.; trade names “YS POLYSTER S”, “YS POLYSTER T”, “MIGHTY ACE G” available from Yasuhara Chemical Co., Ltd.; and so on although not limited to these.

With respect to either one of the first PSA composition and the second PSA composition, when a tackifier resin is used, the amount of tackifier resin can be, for instance, about 50 parts by mass or less relative to 100 parts by mass of the polymer component contained in the PSA composition based on the non-volatiles (solids) content. Usually, it is suitable that the amount used is about 40 parts by mass or less. When the amount of tackifier resin is too large, among the removability, cohesive strength, curved surface adhesion, rough surface adhesion and so on, one, two or more properties may tend to decrease. Although the lower limit of the amount of tackifier resin is not particularly limited, usually, good results can be achieved by using about 1 part by mass or more (typically 5 parts by mass or more) relative to 100 parts by mass of the polymer component.

As the tackifier resin to be contained in the first PSA composition (a composition for forming the first PSA layer), can be preferably used a tackifier resin having a softening point of 125° C. or above (more preferably 130° C. or above, or even more preferably 140° C. or above, typically 180° C. or below). A preferable examples of the first PSA layer contains 10 to 30 parts by mass (e.g., 15 to 25 parts by mass) of a tackifier resin having a softening point above 150° C. (e.g., a tackifier resin having a softening point between 155° C. to 180° C.) relative to 100 parts by mass of the polymer component. This first PSA layer may be essentially free of a tackifier resin having a softening point of 150° C. or below. A double-faced PSA sheet comprising the first PSA layer may exhibit particularly good high-temperature cohesive strength (e.g., cohesive strength at 80° C.) in a cohesive strength measurement (typically carried out by the method described in the worked examples shown later) carried out by adhering the first PSA layer to an adherend.

As the tackifier resin to be contained in the second PSA composition (a composition for forming the second PSA layer), can be used one or two or more kind of a tackifier resin having a softening point of 125° C. or above (more preferably 140° C. to 180° C., e.g., above 150° C., but 180° C. or below) in an amount of 5 to 50 parts by mass, or preferably 20 to 40 parts by mass, relative to 100 parts by mass of the polymer component. As the tackifier resin to be contained in the second PSA composition, can be preferably used a tackifier resin having a softening point below 155° C. (e.g., 60° C. or above, but below 155° C., preferably 70° C. to 150° C., or more preferably 80° C. to 140° C., e.g., 80° C. to 120° C.). In such a double-faced PSA sheet, the second PSA layer may exhibit even better rough surface adhesion. The amount of a tackifier resin having a softening point below 155° C. is suitably 20 parts by mass or less (typically 1 to 20 parts by mass) relative to 100 parts by mass of the polymer component, and it can be, for instance, 5 to 15 parts by mass. As the tackifier resin to be contained in the second PSA composition, may be used also a tackifier resin having a softening point below 155° C. (more preferably 150° C. or below, e.g., below 120° C.) and a tackifier resin having a softening point of 125° C. or above (more preferably 140° C. to 180° C., e.g., above 150° C., but 180° C. or below) in combination (e.g., to an extent where their combined amount used is 5 to 50 parts by mass, or preferably 10 to 40 parts by mass, relative to 100 parts by mass of the polymer component).

The softening point of a tackifier resin as referred to herein is defined as a value measured based on the softening pint test method (ring and ball method) specified in JIS K 5902 and JIS K 2207. In particular, a sample is quickly melted at a lowest possible temperature, and a ring placed on top of a flat metal plate is filled with the melted sample cautiously so as to not form bubbles. After cooled, the portion risen above the plane including the upper rim of the ring is sliced off with a small knife that has been somewhat heated. Following this, a support (ring support) is placed in a glass container (heating bath) having a diameter of 85 mm or larger and a height of 127 mm or higher, and glycerin is poured into this to a depth of 90 mm or deeper. Then, a steel ball (9.5 mm diameter, weighing 3.5 g) and the ring filled with the sample are immersed in glycerin without touching each other, and the temperature of glycerin is maintained at 20° C.±5° C. for 15 minutes. The steel ball is then put at the center of the surface of the sample in the ring, and this is placed on a prescribed location of the support. While keeping the distance between the ring top and the glycerin surface at 50 mm, a thermometer is placed so that the center of the mercury ball of the thermometer is as high as the center of the ring, and the container is heated. By projecting a Bunsen burner flame for heating at the midpoint between the center and the rim of the bottom of the container, heating is made uniform. After the temperature reached 40° C. from the start of heating, the rate of the bath temperature rise must be 5° C.±0.5° C. per minute. As the sample gradually softens, the temperature at which the sample flows out of the ring and finally touches the bottom plate is read as the softening point. Two or more measurements of softening point are performed at the same, and their average value is used.

The first and the second PSA compositions may each comprise an acid or a base (aqueous ammonia, etc.) used for pH adjustment and/or viscosity adjustment, and so on. Examples of other optional components that may be contained in the composition include various kinds of additives generally used in the field of aqueous PSA compositions, such as a viscosity-adjusting agent (a thickening agent, a thinner, etc.), a leveling agent, a plasticizer, a filler, coloring agents such as dyes or pigments, a stabilizer, a preservative, an anti-aging agent, and so on. With respect to these various additives, those heretofore known can be used according to typical methods. Since these does not particularly characterize the present invention, detailed descriptions are omitted.

When the first and the second PSA compositions contain a solvent (water, an organic solvent, or a mixture thereof), the solids content of the PSA compositions may be, for instance, about 30 to 70% by mass (preferably about 40 to 65% by mass, respectively. A preferably usable PSA composition contains about 50 to 70% by mass (e.g., about 50 to 65% by mass, or more preferably about 55 to 65% by mass) of solids. When the solids content is too low, the drying property of the PSA composition may tend to decrease. When the solids content is too high, the viscosity of the composition may increase, and the handling ease or the application ease may tend to decrease. For example, an emulsion-type PSA composition having a solids content in the range described above is preferable. The solids content of a PSA composition as referred to herein indicates, relative to the whole sample, a mass fraction of the portion remaining after the sample is heated at 130° C. for two hours.

The first PSA composition in the art disclosed herein has a weight average molecular weight Mw_{A} of typically 80×10⁴ or larger (i.e., Mw_{A}≧80×10⁴), or preferably 85×10⁴ or larger (e.g., 90×10⁴ or larger), with the Mw_{A} being measured by the method described later. When Mw_{A} is too small, among the removability (e.g., anti-adhesive-residue property), cohesive strength, and curved surface adhesion, at least one property may tend to decrease. The upper limit of Mw_{A} is not particularly limited, but it is usually preferable that the Mw_{A} is 120×10⁴ or smaller, for instance, 110×10⁴ or smaller.

The second PSA composition has a weight average molecular weight Mw_{B} smaller than 80×10⁴ (i.e., Mw_{B}<80×10⁴), or preferably of 75×10⁴ or smaller, when the Mw_{B} is measured by the method described later. When Mw_{B} is too large, the rough surface adhesion of the second PSA layer may tend to decrease. Mw_{B} may be 65×10⁴ or smaller, or may be even 50×10⁴ or smaller. It is usually preferable that Mw_{B} is 25×10⁴ or larger, or it is more preferably 35×10⁴ or larger (e.g., 40×10⁴ or larger). When Mw_{B} is too small, the cohesive strength of the second PSA layer may turn out too low whereby the usability (handling ease) of the double-faced PSA sheet may tend to decrease.

The Mw_{A} and Mw_{B} can be measured by the following method:

### [Method for Measuring Weight Average Molecular Weight]

After drying a PSA composition at 130° C. for two hours, the dried material is suspended in tetrahydrofuran (THF) for 12 hours to extract its THF-soluble portion, and a THF solution containing the THF-soluble portion at a concentration of 0.1 g/L is prepared. A filtrate (a sample solution for a molecular weight measurement) obtained by filtering this THF solution through a membrane filter having an average pore diameter of 0.45 μm is subjected to gel permeation chromatography (GPC), and the weight average molecular weight (based on standard polystyrene) of THF-soluble portion is determined. As the GPC system, can be used, for instance, model name “HLC-8320GPC” (column: TSKgel GMH-H(S)) available from Tosoh Corporation.

In the double-faced PSA sheet disclosed herein, the Mw_{A} is larger than the Mw_{B} by 10×10⁴ or more (i.e., (Mw_{A}−Mw_{B})≧10×10⁴). According to such a double-faced PSA sheet, both good removability in the first adhesive face and good rough surface adhesion in the second adhesive face can be achieved at high levels. Thus, the double-faced PSA sheet can be preferably used for fixing a porous member onto a component for recycling (typically, the first PSA layer is adhered to the component for recycling and the second PSA layer is adhered to the porous member) as well as for other purposes. In a preferable embodiment, (Mw_{A}−Mw_{B}) is 20×10⁴ or larger, or further 25×10⁴ or larger (e.g., 25×10⁴ or larger, but 70×10⁴ or smaller). (Mw_{A}−Mw_{B}) may be even 40×10⁴ or larger (e.g., 40×10⁴ or larger, but 65×10⁴ or smaller).

The respective values of Mw_{A} and Mw_{B} as well as (Mw_{A}−Mw_{B}) can be adjusted by employing solely one or a suitable combination of various means heretofore known. Examples of factors usable for such adjustment include the type and the amount of polymerization initiator used, the polymerization temperature, the monomer composition (e.g., use or non-use of a monomer having an alkoxysilyl group, when used, its type and amount used), use or non-use of a chain transfer agent or a crosslinking agent that is added afterwards, when used, its type and amount used, and so on.

The first and the second PSA compositions may have gel fractions G_{A} and G_{B} respectively of 25 to 60% by mass (e.g., 25 to 50% by mass), with the gel fractions being measured by the method described later. The gel fraction of the first PSA composition, G_{A}, is preferably 30% by mass or larger, or may be 35% by mass or larger. When gel fraction G_{A} is too small, the removability of the first PSA layer may tend to decrease. The gel fraction of the second PSA composition, G_{B}, is preferably 50% by mass or smaller, or may be 45% by mass or smaller. When gel fraction G_{B} is too large, the rough surface adhesion of the second PSA layer may tend to be insufficient.

The G_{A} and G_{B} are measured by the following method.

### [Method for Measuring Gel Fraction]

After a PSA composition is dried at 130° C. for two hours, the dried material (sample) weighing approximately 0.1 g is wrapped into a pouch with a porous polytetrafluoroethylene (PTFE) resin membrane having an average pore diameter of 0.2 μm, and the opening is tied with twine. This pouch is placed in a screw vial of volume 50 mL (one screw vial is used for each pouch), and the screw vial is filled with ethyl acetate. After this is left at room temperature (typically 23° C.) for 7 days, the pouch is taken out and dried at 130° C. for two hours. From the weights of the sample before and after the ethyl acetate immersion, the gel fraction is calculated by the following equation:

Gel fraction=(weight of dried sample after immersion)/(weight of sample before immersion)×100(%)

As the porous PTFE resin membrane, it is desirable to use trade name “NITOFURON (registered trade mark) NTF1122” (0.2 μm average pore diameter, 75% porosity, 0.085 mm thick) available from Nitto Denko Corporation or a similar product.

As the release liner, a liner known or commonly used in the field of double-faced PSA sheets can be suitably selected for use. For example, can be preferably used a release liner having a constitution where a release treatment has been given to the substrate surface. As the substrate (release treatment objective) constituting a release liner of this type, a substrate can be suitably selected for use among various kinds of resin films, papers, fabrics, rubber sheets, foam sheets, metal foils, composites of these (e.g., a sheet having a layered structure in which each face of paper is laminated with an olefin resin), and so on. The release treatment can be performed by a typical method, using a known or commonly used release treatment agent (e.g., a silicone-based, fluorine-based, long-chain-alkyl-based release treatment agent or the like). Or, a poorly adhesive substrate such as an olefin-based resin, a fluorine-based resin, or the like can be used as the release liner without any release treatment given on the substrate surface. Alternatively, such a poorly adhesive substrate can be used after a release treatment is given.

The first and the second PSA compositions can be applied using a known or commonly used coater such as gravure roll coater, reverse roll coater, kiss roll coater, dip roll coater, bar coater, knife coater, spray coater, or the like. Although not particularly limited, the coating amount of each PSA composition can be so as to form a PSA layer having a thickness of, for instance, about 20 μm to 150 μm (typically about 40 μm to 100 μm, e.g., 50 μm to 70 μm) after dried (i.e., based on the solids content). From the standpoint of facilitating the crosslinking reaction or increasing the production efficiency, etc., the PSA composition is preferably dried with heating. Although it also depends on the type of the coated material (a porous substrate or a process liner), for instance, a drying temperature of about 40° C. to 120° C. can be preferably used.

The double-faced PSA sheet disclosed herein may exhibit good weathering resistance because the base polymers of its first and second PSA layers are both acrylic polymers. This is advantageous in an application such that the PSA sheet is removed after a long time has passed from adhesion (e.g., after a home appliance reaches its end of life) so as to maintain good removability after such a long time has passed. When the support of the double-faced PSA sheet is a porous member (e.g., a non-woven fabric), because the base polymers of the first and the second PSA layers are both acrylic polymers, the PSA layers provided on the first face and the second face of the support may be merged with each other inside the support. Such merging of PSA layers may advantageously contribute to prevention of an interlaminar fracture when the double-faced PSA sheet is removed.

With respect to the double-faced PSA sheet disclosed herein, when a 10 mm thick soft urethane foam (trade name “ECS” (gray color) available from Inoac Corporation is used) is pressure-bonded to the second adhesive face under a condition where the urethane foam is compressed to a thickness of 1 mm (90% compression), it may exhibit a 180° peel strength of 1.0 N/20 mm or greater (in a preferable embodiment, 1.5 N/20 mm or greater, e.g., 2.0 N/20 mm or greater) after a lapse of 30 minutes from the pressure-bonding. When pressure-bonded under a condition where the urethane foam is compressed to a thickness of 5 mm (50% compression), it may exhibit a 180° peel strength of 0.3 N/20 mm or greater (e.g., 0.4 N/20 mm or greater) after a lapse of 30 minutes from the pressure-bonding. A double-faced PSA sheet that satisfies one or both of these properties (180° peel strength values) is preferable for fixing a porous member such as soft urethane foam and others to a resin compact (which may be a component for recycling). More specifically, the 180° peel strength against the soft urethane foam (peel strength of the second adhesive face against soft urethane foam) may be measured by the method described in the worked examples shown later.

The double-faced PSA sheet disclosed herein can be preferably used for an application where the first PSA layer and the second PSA layer are adhered to a first adherend and a second adherend, respectively, so as to join the first adherend and the second adherend together. Especially, when it is used in an embodiment where after constituting such a joined body, the first adhesive face of the double-faced PSA sheet is removed from the first adherend (more preferably in an embodiment where the second adhesive face of the double-faced PSA sheet does not need to be removed from the second adherend), it is preferable because the advantages of the double-faced PSA sheet disclosed herein can be effectively exhibited.

The first adherend to which the first adhesive face (face on the side to be removed) may be a component formed from a variety of materials such as an organic material, an inorganic material (glass, alumina, zirconia, silica, etc.), a metal material (aluminum, stainless steel, copper, zinc, etc.), a composite of these, or the like. It is preferably a compact (in other words, non-porous) component. Examples of the organic material include thermoplastic resins such as polycarbonates (PC), styrene-based resins (general polystyrene resins, high-impact polystyrenes (HIPS), styrene-acrylonitrile copolymer resins, acrylonitrile-butadiene-styrene copolymers (ABS), polymer alloys of PC and ABS (PCABS), styrene-acrylonitrile resins, etc.), polyesters (polyethylene terephthalate, polybutylene terephthalate, etc.), polyphenylene sulfides, polyacetals, polyolefins (polyethylene, polypropylene, etc.), aliphatic polyamides (nylon), aromatic polyamide, epoxy resins, urethane resins, acrylic resins (polymethyl methacrylate, etc.), vinyl chloride resins, thermoplastic elastomers (e.g., polyolefin-based thermoplastic elastomers), and the like. Other examples of the organic material include rubbers such as natural rubbers, butyl rubbers, and the like. As the first adherend, can be preferably used a resin compact product formed using a thermoplastic resin as listed above (e.g., HIPS, PCABS, PC, etc., are preferable).

The second adherend to which the second adhesive face (typically, a face not to be removed) is adhered may be a component formed similarly to the first adherend using an organic material, an inorganic material, a metal material, a composite of these, or the like. At least the surface of this second adherend is preferably porous. A representative example of the second adherend preferable for the present invention is a second adherend that is entirely porous. In an application where such a second adherend is fixed to a first adherend, the advantages of employing the double-faced PSA sheet disclosed herein may be especially well exhibited. The porous member may be of any of various fibrous substances (natural fibers, semisynthetic fibers, synthetic fibers). For instance, it may be a member having a shape of a sheet or other shapes, which has been formed using a type of fabric such as a woven or a non-woven fabric of a single species or a blend of cotton fiber, staple fiber, Manilla hemp, pulp, rayon, acetate fiber, polyester fiber, polyvinyl alcohol fiber, polyamide fiber, polyolefin fiber, etc.; a foam such as a urethane foam, a chloroprene rubber foam, etc.; or the like. Preferable examples include soft urethane foams, flame-retardant non-woven fabrics, and the like. For example, a flame-retardant non-woven fabric having flame resistance equivalent to or higher than UL94V-0 grade in the safety standards by Underwriters Laboratories Inc., (UL) is preferable.

A preferable example of an embodiment of the actual application of the double-faced PSA sheet disclosed herein is an embodiment where the first adherend is a chassis of a home appliance, an electronic device, or an OA equipment, etc., and a second adherend (e.g., a porous member such as a soft urethane foam, a flame-retardant non-woven fabric, etc.) is fixed to the chassis (e.g., inner surfaces of the chassis).

### EXAMPLES

Several worked examples relating to the present invention are described below, but the present invention is not intended to be limited to these examples. In the description below, “parts” and “%” are based on the weight unless otherwise specified.

In the following descriptions, the weight average molecular weights and gel fractions were measured as follows, respectively:

### [Weight Average Molecular Weight]

Each PSA composition after dried at 130° C. for two hours was immersed in THF for 12 hours to extract its THF-soluble portion, and was prepared a THF solution containing the THF-soluble portion at a concentration of 0.1 g/L. A filtrate (a sample solution for a molecular weight measurement) obtained by filtering this THF solution through a membrane filter having an average pore diameter of 0.45 μm was subjected to GPC, and the weight average molecular weight (based on standard polystyrene) of the THF-soluble portion was determined. As the GPC system, was used model name “HLC-8320GPC” (column: TSKgel GMH-H(S)) available from Tosoh Corporation.

### [Gel Fraction]

After a PSA composition was dried at 130° C. for two hours, the dried material (sample) weighing approximately 0.1 g was wrapped into a pouch with a PTFE resin membrane (trade name “NITOFURON (registered trade mark) NTF1122” available from Nitto Denko Corporation was used), and the opening was tied with twine. This pouch was placed in a screw vial of volume 50 mL, and the screw vial was filled with ethyl acetate. After this was left at room temperature (typically 23° C.) for 7 days, the pouch was taken out and dried at 130° C. for two hours. Based on the next equation: Gel fraction=(weight of dried sample after immersion)/(weight of sample before immersion)×100(%); the gel fraction was calculated.

The PSA compositions used in preparation of double-faced PSA sheets were prepared respectively as follows:

### [PSA Composition C1]

To a reaction vessel equipped with a condenser, a nitrogen inlet, a thermometer and a stirrer, was placed 40 parts of ion-exchanged water (deionized water), and it was stirred under a nitrogen gas flow at 60° C. for longer than one hour. To this reaction vessel, was added 0.1 part of 2,2′-azobis[2-(5-methyl-2-imidazolin-2-yl)propane]dihydrochloride (polymerization initiator). While maintaining the system at 60° C., to this was gradually added dropwise a monomer emulsion over four hours to carry out emulsion polymerization reaction. As the monomer emulsion, was used an emulsion prepared by adding to and emulsifying in 30 parts of ion-exchanged water, 70 parts of 2EHA, 30 parts of BA, 1.5 parts of AA, 2.5 parts of MAA, 0.033 part of n-lauryl mercaptan (chain transfer agent), 0.02 part of γ-methacryloxypropyltrimethoxysilane (trade name “KBM-503” available from Shin-Etsu Chemical Co., Ltd.), and 2 parts of sodium polyoxyethylene lauryl sulfate (emulsifier). After the addition of the monomer emulsion was completed, it was further maintained at 60° C. for three hours, and then were added 0.2 part of 35% hydrogen peroxide solution and 0.6 part of ascorbic acid. After the system was cooled to room temperature, the pH was adjusted to 7 by adding 10% aqueous ammonia to obtain an acrylic polymer emulsion (a water-dispersed acrylic polymer). This acrylic polymer has a Tg of −47° C.

Relative to 100 parts of the acrylic polymer contained in the acrylic polymer emulsion, was added and mixed 20 parts of a tackifier emulsion based on the solids content. As the tackifier emulsion, was used an aqueous emulsion of a polymerized rosin ester having a softening point of 160° C. (trade name “E-865NT” available from Arakawa Chemical Industries, Ltd.). The pH was adjusted to 7.2 and the viscosity was adjusted to 10 Pa·s, by suitably using 10% aqueous ammonia as a pH-adjusting agent and a polyacrylic acid as a thickening agent (trade name “ARON B-500” available from Toagosei Co., Ltd.). The viscosity was measured using a model B viscometer with rotor No. 5 at a rotation speed of 20 rpm and a liquid temperature of 30° C. over a measurement time of 1 minute. This PSA composition C1 had a Mw of 99.7×10⁴ and a gel fraction of 40% as determined by the methods described earlier.

### [PSA Composition C2]

In this example, as the monomer emulsion, was used an emulsion prepared by adding to and emulsifying in 30 parts of ion-exchanged water, 30 parts of 2EHA, 70 parts of BA, 3.0 parts of AA, 0.05 part of n-lauryl mercaptan, 0.03 part of γ-methacryloxypropyltrimethoxysilane, and 2 parts of sodium polyoxyethylene lauryl sulfate. In the same manner as PSA composition C1 with respect to the other conditions, was obtained an acrylic polymer emulsion. This acrylic polymer has a Tg of −31° C.

As the tackifier resin emulsion, relative to 100 parts of the acrylic polymer contained in the acrylic polymer emulsion, was used 30 parts of an aqueous emulsion of a rosin phenol having a softening point of 150° C. (trade name “E-200NT” available from Arakawa Chemical Industries, Ltd.) based on the solids content. In the same manner as PSA composition C1 with respect to the other conditions, was prepared PSA composition C2 having a pH of 7.2 and a viscosity of 10 Pa·s. As determined by the methods described earlier, the Mw was 72.5×10⁴ and the gel fraction was 30%.

### [PSA Composition C3]

In this example, as the monomer emulsion, was used an emulsion prepared by adding to and emulsifying in 30 parts of ion-exchanged water, 85 parts of 2EHA, 13 parts of methyl acrylate (MA), 1.25 parts of AA, 0.75 part of MAA, 0.048 part of n-lauryl mercaptan, 0.02 part of γ-methacryloxypropyltrimethoxysilane, and 2 parts of sodium polyoxyethylene lauryl sulfate. In the same manner as PSA composition C1 with respect to the other conditions, was obtained an acrylic polymer emulsion. This acrylic polymer has a Tg of −30° C.

As the tackifier resin emulsion, relative to 100 parts of the acrylic polymer contained in the acrylic polymer emulsion, were used 20 parts of an aqueous emulsion of a polymerized rosin ester having a softening point of 160° C. (trade name “E-865NT” available from Arakawa Chemical Industries, Ltd.) and 10 parts of an aqueous emulsion of a rosin ester having a softening point of 100° C. (trade name “NS100H” available from Arakawa Chemical Industries, Ltd.). In the same manner as PSA composition C1 with respect to the other conditions, was prepared PSA composition C3 having a pH of 7.2 and a viscosity of 10 Pa·s. As determined by the methods described earlier, the Mw was 44.9×10⁴ and the gel fraction was 40%.

A summary of these PSA compositions C1 to C3 is shown in Table 1.

TABLE 1

| | Composition C1 | | Compostion C2 | | Composition C3 | |
|---|---|---|---|---|---|---|
| Monomer | 2EHA | 70 | 2EHA | 30 | 2EHA | 85 |
| composition | BA | 30 | BA | 70 | BA | — |
| | MA | — | MA | — | MA | 13 |
| | AA | 1.5 | AA | 3 | AA | 1.25 |
| | MAA | 2.5 | MAA | — | MAA | 0.75 |

| | | | |
|---|---|---|---|
| Tg | −47° C. | −31° C. | −30° C. |
| Tackifier | E-865NT | E-200NT | E-865NT/NS-100H |
| resin type | 20 parts | 30 parts | 20 parts/10 parts |
| amount used | | | |
| (per 100 parts | | | |
| of polymer) | | | |
| Mw of PSA | 99.7 × 10⁴ | 72.5 × 10⁴ | 44.9 × 10⁴ |
| layer | | | |
| Gel fraction | 40% | 30% | 40% |

Using the PSA compositions C1 to C3 and non-woven fabrics as the supports, double-faced PSA sheets were prepared. As the non-woven fabrics, the following two species were used.

B1: a non-woven fabric (23.6 g/m² grammage, 80 μm thick) formed of 100% hemp and impregnated with viscose.

B2: a non-woven fabric (23.0 g/m² grammage, 50 μm thick) formed of 100% hemp and impregnated with viscose.

### Example 1

Two sheets of release liner (trade name “75 EPS (M) Cream (Kai)” available from Oji Specialty Paper Co., Ltd.) having a release layer formed of a silicone-based release agent were prepared. Of these, PSA composition C1 was applied to a first sheet of release liner and dried at 100° C. for two minutes to form a first PSA layer of approximately 60 μm thickness. To the second sheet of release liner, PSA composition C2 was applied and dried at 100° C. for two minutes to form a second PSA layer of approximately 60 μm thickness. The first and the second PSA layers formed on these release liners were adhered to a first face and a second face of non-woven fabric substrate B1, respectively, to prepare a double-faced PSA sheet according to this example. Each of the adhesive faces of this PSA sheet is protected as is with the release liner used in preparation of the PSA sheet.

### Example 2

In this example, in place of the non-woven fabric substrate in Example 1, non-woven fabric B2 was used. In the same manner as Example 1 with respect to other conditions, was prepared a double-faced PSA sheet according to this example.

### Example 3

In this example, using PSA composition C3, a second PSA layer of about 60 μm thickness was formed on the second sheet of release liner. In the same manner as Example 1 with respect to other conditions, was prepared a double-faced PSA sheet according to this example.

### Example 4

In this example, in place of the non-woven fabric substrate in Example 3, non-woven fabric B2 was used. In the same manner as Example 3 with respect to other conditions, was prepared a double-faced PSA sheet according to this example.

### Example 5

In this example, using PSA composition C2, a first PSA layer of about 60 μm thickness was formed on the first sheet of release liner. In the same manner as Example 1 with respect to other conditions, was prepared a double-faced PSA sheet according to this example.

### Example 6

In this example, using PSA composition C3, a first PSA layer of about 60 μm thickness was formed on the first sheet of release liner, and using PSA composition C3, a second PSA layer of about 60 μm thickness was formed on the second sheet of release liner. In the same manner as Example 1 with respect to other conditions, was prepared a double-faced PSA sheet according to this example.

### Example 7

In this example, using PSA composition C1, a second PSA layer of about 60 μm thickness was formed on the second sheet of release liner. In the same manner as Example 1 with respect to other conditions, was prepared a double-faced PSA sheet according to this example.

Test samples of the resulting double-faced PSA sheets after stored in an environment at 50° C. for three days were subjected to the following evaluations. Their results are shown in Table 2.

### [Peel Strength of First Adhesive Face]

The release liner covering the second adhesive face of a double-faced PSA sheet was peeled off, and a 25 μm thick polyethylene terephthalate (PET) film was adhered for backing. The backed PSA sheet was cut into a size of 20 mm wide by 100 mm long to prepare a test piece. The release liner covering the first adhesive face of the test piece was peeled off, and the test piece was pressure-bonded to an adherend by moving a 2 kg roller back and forth once. After this was left at 23° C. for 30 minutes, based on JIS Z0237, using a tensile tester, the 180° peel strength (N/20 mm-width) with respect to the first adhesive face was measured at a tensile speed of 300 mm/min in an environment at 23° C. and 50% RH. As the adherend, were used three different types, namely, SUS (SUS 304BA plate), PC (polycarbonate plate available from Takiron Co., Ltd.) and PSt (polystyrene plate available from RP Topla, Ltd.). The measurement was performed three times for each. Their arithmetic mean values are shown in Table 2.

### [Peel Strength of Second Adhesive Face]

(Against ECS foam; 90% compression rate)

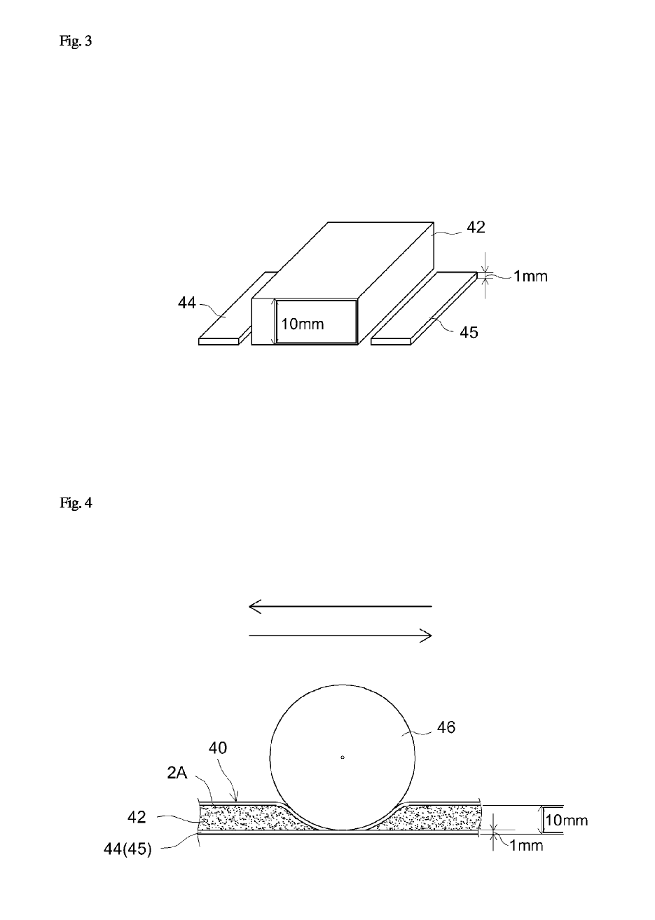

As the adherend, a 10 mm thick soft urethane foam (trade name “ECS” (gray color) available from Inoac Corporation) was cut into a size of 30 mm wide by 100 mm long. As shown in FIG. 3, 1 mm thick aluminum members (spacers) 44 and 45 were placed on both sides across the width direction of the urethane foam (ECS foam) 42, leaving a space of approximately 0.1 mm at each side.

The release liner covering the first adhesive face of a double-faced PSA sheet was peeled off, and a 25 μm thick PET film was adhered for backing. The backed PSA sheet was cut into a size of 20 mm wide by 100 mm long to prepare a test piece. The release liner covering the second adhesive face of the test piece was peeled off to approximately the ⅔ line from one end of the length direction of the test piece. As shown in FIG. 4, with the second adhesive surface 2A thus exposed facing downward, the test piece 40 was placed on top of the urethane foam 42 and was pressure-bonded by moving a roller 46 of having a weight of 2 kg and a diameter of 85 mm back and forth once into the length direction of the test piece 40 at a speed of 30 cm/min. During this, the roller 46 compressed the urethane foam 42 to a thickness of 1 mm (to a 10% of the original thickness, i.e., by 90% compression rate) while it is rolled along the tops of the spacers 44 and 45.

After the test piece pressure-bonded to the urethane foam was stored at 23° C. for 30 minutes, based on JIS Z0237 (2004), using a tensile tester, the 180° peel strength (peel strength against ECS (90% compression rate)) with respect to the second adhesive face was measured at a tensile speed of 300 mm/min in an environment at 23° C. and 50% RH. The measurement was carried out over a length of at least 10 mm. The measurement was performed three times for each. Their arithmetic mean values are shown in Table 2.

(Against ECS foam; 50% compression rate)

5 mm thick aluminum members were used in place of 1 mm thick aluminum members (spacers) 44 and 45 in the peel strength measurement against ECS (90% compression rate). In the same manner as the peel strength measurement against ECS (90% compression rate) with respect to the other conditions, the 180° peel strength (peel strength against ECS (50% compression rate)) with respect to the second adhesive face was measured. The results are shown in Table 2.

### (Against Flame-Retardant Non-Woven Fabric)

A double-faced PSA sheet was backed by adhering a 25 μm thick PET film to the first adhesive face. The backed PSA sheet was cut into a size of 20 mm wide by 100 mm long to prepare a test piece. The second adhesive face of the test piece was pressure-bonded to a flame-retardant non-woven fabric by moving a 2 kg roller back and forth once. After this was left at 23° C. for 30 minutes, in based on JIS Z0237 (2004), using a tensile tester, the 180° peel strength with respect to the second adhesive face was measured at a tensile speed of 300 mm/min in an environment at 23° C. and 50% RH. The measurement was performed three times for each. Their arithmetic mean values are shown in Table 2.

As the flame-retardant non-woven fabric, was used trade name “VI-BLACK DS-25VP” available from Japan Vilene Corporation. The DS-25VP is a flame-retardant non-woven fabric certified to UL 94V-0.

### [Cohesive Strength (First Adhesive Face)]

The release liner covering the second adhesive face of a double-faced PSA sheet was peeled off, and a 25 μm thick PET film was adhered for backing. This was cut to a width of 10 mm, and three test pieces were prepared of the PSA sheet according to each Example. The release liner was removed from the first adhesive face of each test piece, and the test piece was adhered to a phenol resin plate as the adherend over an adhesion area of 10 mm wide by 20 mm long. After this was left in an environment at 23° C. for 30 minutes, the phenol resin plate was vertically hung, and a load of 500 g was applied to the free end of the test piece. Based on JIS Z 0237 (2004), this was left with the applied load in an environment at 40° C. for one hour (40° C.×1 hr). After a lapse of one hour, when at least one of the three test pieces fell off, the retention time was determined to be less than one hour (shown as “Fell” in Table 2). Otherwise, with respect to the three test pieces, the distances (mm) over which the respective test pieces had shifted from the initially-bonded positions were measured. Cohesive strength of the first adhesive face was evaluated in the same manner as the above method except that the temperature where the test piece is left with the applied load is 80° C. (80° C.×1 hr). There arithmetic mean values are shown in Table 2.

### [Curved Surface Adhesion (First Adhesive Face)]

A double-faced PSA sheet was cut to 20 mm wide by 180 mm long, and, with the release liner covering the second adhesive face peeled off, it was adhered to an aluminum strip (0.4 mm thick) of the same size to prepare a test piece. From the first adhesive face of the test piece, the release liner was removed, and using a laminating equipment, the test piece was pressure-bonded to the center of an acrylonitrile-butadiene-styrene (ABS) plate (30 mm wide, 200 mm long, 2 mm thick) available from Shin-Kobe Electric Machinery Co., Ltd., as the adherend. After this was left in an environment at 23° C. and 50% RH for one day, it was set in a jig having a 190 mm wide space with the length direction of the ABS plate curved to form an arc, and was stored in an environment at 70° C. for 72 hours. Following this, whether or not the ends of the length direction of the test piece were floated off the surface of the adherend (ABS plate) was visually observed. When any floating was observed, the floating distance from the adherend surface was measured. The measurement was performed using three test pieces for each. As a result, floating of the test piece was not observed with respect to any of Examples 1 to 7. In other words, there observed no negative effects on the curved surface adhesion by applying the constitution of the present invention.

### [Removability (First Adhesive Face)]

In the same manner as the peel strength measurement for the first adhesive face described above, the first adhesive face of a test piece backed with a PET film adhered to the second adhesive face was pressure-bonded to each of three types of adherend, namely SUS, PC, and PSt. This was left at 40° C. or at 60° C. for 15 days and then left in an environment at 23° C. and 50% RH for one day. Following this, using a tensile tester, the peel strength (N/20 mm-width) was measured at a tensile speed of 300 mm/min. The measurement was performed three times for each. Their arithmetic mean values are shown in Table 2.

The adherend after such peel strength test was photographed from directly above (from the normal direction), and the resulting photograph was printed out on a piece of copier paper (PPC paper). From the print out, the portion corresponding to the area of adherend to which the test piece had been adhered was cut out. Furthermore, the test-piece-adhered portion was divided by cutting into a portion where peeling had occurred at the interface between the first PSA layer and the adherend (i.e., portion of the adherend surface left with no residues of the double-faced PSA sheet; interfacially fractured portion) and the rest (non-interfacially fractured portion); and the respective masses were measured. From the mass of the interfacially fractured portion, W_{S}, and the non-interfacially fractured portion, W_{N}, was calculated the percent area of interfacial fracture. The results (arithmetic mean values of three test pieces each) are shown in Table 2.

% area of interfacial fracture=W_{S}/(W_{S}+W_{N})×100

When the percent area of interfacial fracture was 70% or greater, the removability was rated G (good), and when it was smaller than 70%, the removability was rated P (poor).

TABLE 2

| | | | 1 | 2 | 3 | 4 | 5 | 6 | 7 |
|---|---|---|---|---|---|---|---|---|---|
| Configuration | Non-woven fabric | | B1 | B2 | B1 | B2 | B1 | B1 | B1 |
| | 1st PSA composition | | C1 | C1 | C1 | C1 | C2 | C3 | C1 |
| | 2nd PSA composition | | C2 | C2 | C3 | C3 | C2 | C3 | C1 |
| 180° Peel | 1st | against SUS | 13 | 14 | 14 | 13 | 16 | 18 | 13 |
| strength | adhesive | against PC | 16 | 17 | 17 | 16 | 20 | 22 | 16 |
| (N/20 mm) | face | against PSt | 14 | 16 | 16 | 14 | 16 | 18 | 14 |
| | 2nd | against ECS | 2 | 3 | 3 | 2 | 2 | 2 | 0.5 |
| | adhesive | (90% compression rate) | | | | | | | |
| | face | against ECS | 0.5 | 0.5 | 0.5 | 0.5 | 0.5 | 0.5 | 0.1 |
| | | (50% compression rate) | | | | | | | |
| | | against flame-retardant | 2 | 2 | 2 | 2 | 2 | 2 | 0.5 |
| | | non-woven fabric | | | | | | | |
| Cohesive | 1st | 40° C. × 1 hr | 1 | 1 | 1 | 1 | 1 | 2 | 1 |
| strength | adhesive | 80° C. × 1 hr | 1 | 1 | 1 | 1 | Fell | Fell | 1 |
| (mm) | face | | | | | | | | |
| Evaluation of | SUS | Removability | G | G | G | G | G | G | G |
| removability | | % area of interfacial fracture | 100 | 100 | 100 | 100 | 100 | 100 | 100 |
| 40° C. × 15 | | Peel strength (N/20 mm) | 17 | 17 | 17 | 17 | 20 | 20 | 17 |
| days | PC | Removability | G | G | G | G | P | P | G |
| | | % area of interfacial fracture | 100 | 100 | 100 | 100 | 50 | 50 | 100 |
| | | Peel strength (N/20 mm) | 17 | 17 | 17 | 17 | 25 | 25 | 17 |
| | PSt | Removability | G | G | G | G | P | P | G |
| | | % area of interfacial fracture | 100 | 100 | 100 | 100 | 50 | 50 | 100 |
| | | Peel strength (N/20 mm) | 17 | 17 | 17 | 17 | 25 | 25 | 17 |
| Evaluation of | SUS | Removability | G | G | G | G | P | P | G |
| removability | | % area of interfacial fracture | 100 | 100 | 100 | 100 | 50 | 25 | 100 |
| 60° C. × 15 | | Peel strength (N/20 mm) | 20 | 20 | 20 | 20 | 20 | 20 | 20 |
| days | PC | Removability | G | G | G | G | P | P | G |
| | | % area of interfacial fracture | 80 | 80 | 80 | 80 | 0 | 0 | 80 |
| | | Peel strength (N/20 mm) | 20 | 20 | 20 | 20 | 25 | 25 | 20 |
| | PSt | Removability | G | G | G | G | P | P | G |
| | | % area of interfacial fracture | 100 | 100 | 100 | 100 | 0 | 0 | 100 |
| | | Peel strength (N/20 mm) | 18 | 18 | 18 | 18 | 25 | 25 | 18 |

As evident from Table 1 and Table 2, with respect to the double-faced PSA sheets of Examples 1 to 4 (all satisfying Mw_{A}≧80×10⁴, Mw_{B}<80×10⁴, and (Mw_{A}−Mw_{B})≧10×10⁴), each with the first PSA layer formed of composition C1 and the second PSA layer formed of composition C2 or C3, all their first adhesive surfaces exhibited good adhesion against various types of adherend (12 N/20 mm or greater all against metal and two different types of resin) and high cohesive strength as well as good removability from the adherends. These double-faced PSA sheets according to Examples 1 to 4 exhibited good rough surface adhesion on the second adhesive faces as well.

On the contrary, with respect to the double-faced PSA sheets of Examples 5 to 7, each with the first and the second PSA layers formed of the same PSA composition, as the attempt to obtain desirable rough surface adhesion resulted in insufficient removability (Example 5, Example 6) and the attempt to obtain desirable removability resulted in insufficient rough surface adhesion (Example 7), these properties could not be combined at high levels.

As described above, because the double-faced PSA sheet disclosed herein comprises a first adhesive face with good removability and a second face with good rough surface adhesion, it is preferably used for fixing a porous member (e.g., a flexible foam such as a foam and soft urethane foam, or the like) or a non-woven fabric (e.g., a flame-retardant non-woven fabric, etc.) to a component to be recycled (including a case where the component is recycled as is, and a case where its constituents are recycled) in various industrial fields such as home appliances, automobiles, OA devices, and others. In addition, since the double-faced PSA sheet disclosed herein may also combine good adhesive properties, its use is not limited to components for recycling, and it can be preferably used in various fields.

What is claimed is:

1. A double-faced pressure-sensitive adhesive sheet comprising:
a substrate having a first face and a second face;
a first pressure-sensitive adhesive layer provided on the first face; and
a second pressure-sensitive adhesive layer provided on the second face, wherein
the first pressure-sensitive adhesive layer is formed of a first pressure-sensitive adhesive composition comprising an acrylic polymer P_{A} as a base polymer,
the second pressure-sensitive adhesive layer is formed of a second pressure-sensitive adhesive composition comprising an acrylic polymer P_{B} as a base polymer, and
Mw_{A}, which is the weight average molecular weight of a tetrahydrofuran-soluble portion of the first pressure-sensitive adhesive composition after dried, and Mw_{B}, which is the weight average molecular weight of a tetrahydrofuran-soluble portion of the second pressure-sensitive adhesive composition after dried, satisfy the following inequalities:
Mw_{A}≧80×10⁴;
Mw_{B}<80×10⁴; and
(Mw_{A}−Mw_{B})≧10×10⁴.

2. The double-faced pressure-sensitive adhesive sheet according to claim 1, wherein at least one of the acrylic polymer P_{A} and the acrylic polymer P_{B} is a polymer obtained by polymerizing monomer components comprising two kinds of alkyl (meth)acrylate, Ama1 and Ama2, with their alkyl groups having different numbers of carbon atoms.

3. The double-faced pressure-sensitive adhesive sheet according to claim 1, wherein at least one of the acrylic polymer P_{A} and the acrylic polymer P_{B} is a polymer obtained by polymerizing monomer components comprising two kinds of alkyl (meth)acrylate, Ama1 and Ama2, with their alkyl groups having different numbers of carbon atoms, wherein
the Ama1 is a component accounting for the largest amount based on the mass among alkyl (meth)acrylates contained in the monomer components, and the Ama2 is a component accounting for as large an amount as the Ama1 or for an amount next largest after the Ama1 based on the mass among alkyl (meth)acrylates contained in the monomer components, and
the Ama1 and the Ama2 account for a total content of 40% by mass or greater in the total amount of alkyl (meth)acrylates contained in the monomer components.

4. The double-faced pressure-sensitive adhesive sheet according to claim 1, wherein the Mw_{A} and the Mw_{B} satisfy the following inequalities:
(Mw_{A}−Mw_{B})≧25×10⁴.

5. The double-faced pressure-sensitive adhesive sheet according to claim 1, wherein
when the second pressure-sensitive adhesive layer is pressure-bonded to a 10 mm thick soft urethane foam until the urethane foam is compressed to a thickness of 1 mm, after a lapse of 30 minutes from the pressure-bonding, it exhibits a 180° peel strength of 1.5 N/20 mm or greater.

6. The double-faced pressure-sensitive adhesive sheet according to claim 1 for use where the first pressure-sensitive adhesive layer is adhered to a component for recycling, and the second pressure-sensitive adhesive layer is adhered to a porous member.

7. The double-faced pressure-sensitive adhesive sheet according to claim 2, wherein at least one of the acrylic polymer P_{A} and the acrylic polymer P_{B} is a polymer obtained by polymerizing monomer components comprising two kinds of alkyl (meth)acrylate, Ama1 and Ama2, with their alkyl groups having different numbers of carbon atoms, wherein
the Ama1 is a component accounting for the largest amount based on the mass among alkyl (meth)acrylates contained in the monomer components, and the Ama2 is a component accounting for as large an amount as the Ama1 or for an amount next largest after the Ama1 based on the mass among alkyl (meth)acrylates contained in the monomer components, and
the Ama1 and the Ama2 account for a total content of 40% by mass or greater in the total amount of alkyl (meth)acrylates contained in the monomer components.

8. The double-faced pressure-sensitive adhesive sheet according to claim 2, wherein the Mw_{A} and the Mw_{B} satisfy the following inequalities:
(Mw_{A}−Mw_{B})≧25×10⁴.

9. The double-faced pressure-sensitive adhesive sheet according to claim 2, wherein
when the second pressure-sensitive adhesive layer is pressure-bonded to a 10 mm thick soft urethane foam until the urethane foam is compressed to a thickness of 1 mm, after a lapse of 30 minutes from the pressure-bonding, it exhibits a 180° peel strength of 1.5 N/20 mm or greater.

10. The double-faced pressure-sensitive adhesive sheet according to claim 2 for use where the first pressure-sensitive adhesive layer is adhered to a component for recycling, and the second pressure-sensitive adhesive layer is adhered to a porous member.

11. The double-faced pressure-sensitive adhesive sheet according to claim 3, wherein the Mw_{A} and the Mw_{B} satisfy the following inequalities:
(Mw_{A}−Mw_{B})≧25×10⁴.

12. The double-faced pressure-sensitive adhesive sheet according to claim 3, wherein when the second pressure-sensitive adhesive layer is pressure-bonded to a 10 mm thick soft urethane foam until the urethane foam is compressed to a thickness of 1 mm, after a lapse of 30 minutes from the pressure-bonding, it exhibits a 180° peel strength of 1.5 N/20 mm or greater.

13. The double-faced pressure-sensitive adhesive sheet according to claim 3 for use where the first pressure-sensitive adhesive layer is adhered to a component for recycling, and the second pressure-sensitive adhesive layer is adhered to a porous member.

14. The double-faced pressure-sensitive adhesive sheet according to claim 4, wherein
when the second pressure-sensitive adhesive layer is pressure-bonded to a 10 mm thick soft urethane foam until the urethane foam is compressed to a thickness of 1 mm, after a lapse of 30 minutes from the pressure-bonding, it exhibits a 180° peel strength of 1.5 N/20 mm or greater.

15. The double-faced pressure-sensitive adhesive sheet according to claim 4 for use where the first pressure-sensitive adhesive layer is adhered to a component for recycling, and the second pressure-sensitive adhesive layer is adhered to a porous member.

16. The double-faced pressure-sensitive adhesive sheet according to claim 5 for use where the first pressure-sensitive adhesive layer is adhered to a component for recycling, and the second pressure-sensitive adhesive layer is adhered to a porous member.
